(19) United States
(12) Patent Application Publication
(10) Pub. No.: US 2011/0256888 A1
(43) Pub. Date: Oct. 20, 2011

(54) Message over Cell phone System

(75) Inventors: Dalton Hayhurst, Redding, CA (US); Chris Carmichael, Laguna Niguel, CA (US); Connie Jordan, Laguna Niguel, CA (US)

(73) Assignee: UBIQUITY HOLDINGS, San Juan Capistrano, CA (US)

(21) Appl. No.: 12/860,147

(22) Filed: Aug. 20, 2010

Related U.S. Application Data
(60) Provisional application No. 61/235,726, filed on Aug. 21, 2009.

(51) Int. Cl. H04W 24/00; G06F 15/16

(52) U.S. Cl. 455/456.3; 709/206

(57) ABSTRACT

A social networking technique and site that sends information based on current time and on interests. An embodiment sends information by text messages.

This application claims priority from provisional application No. 61/235,726, filed Aug. 21, 2009, the entire contents of which are herewith incorporated by reference.

### BACKGROUND

Today's cell phones have become ubiquitous not only as communication devices, but also as devices to organize and obtain information. Cell phones typically contain the user's complete contact list, as well as Internet access and others. Different modes of communication are available to cell phones, with telephone calls being the only one of those modes of communications.

SMS messages are also ubiquitous. It is estimated that the number of SMS messages sent each day exceeds the population of the world.

### SUMMARY

The present application describes a portable hand-held device which may include a cell phone. The device wirelessly locates mobile users, and provides location-sensitive information.

### BRIEF DESCRIPTION OF THE DRAWINGS

in the drawings:

FIG. 1 shows a block diagram of an overall system;

FIG. 2 shows a flowchart of operation;

FIG. 3 shows different categories for the ad embodiment;

FIG. 4 shows more detail on the categories.

### DETAILED DESCRIPTION

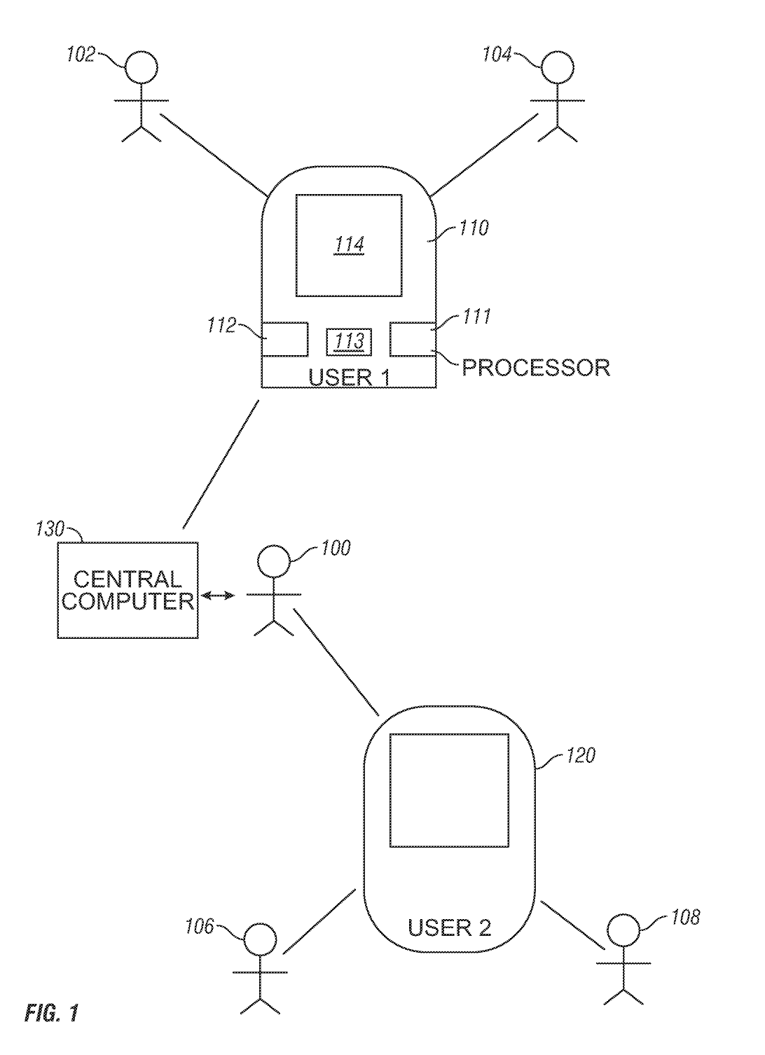

FIG. 1 shows a block diagram of an overall system. According to an embodiment, the advertising system that is used according to the present system wirelessly locates mobile users. This can use, for example, GSM; satellite positioning, triangulation among cell towers or any other location technique to determine the location of a mobile user handset.

Users once located, then receive at least one SMS messages describing deals and offers for surrounding restaurants, entertainment, hotels, and businesses according to this embodiment.

A block diagram is shown in FIG. 1. A number of existing cell towers, including cell towers 100, 102, 104, 106, 108 are shown spread among various locations. According to the diagram, there are also two users shown as user one 110 and user two 120. Of course, there may be many more users, and many more cell towers, but this is shown to be indicative of an overall system.

A central computer 130 may be connected to one or more of the cell towers. This may be for example the central computer or operated by the cellular carrier. The cell phones such as 110 each also include a processor 111, as well as memory 112 that stores various information. The cell phones include a keyboard 113 and a display 114 on which data can be displayed.

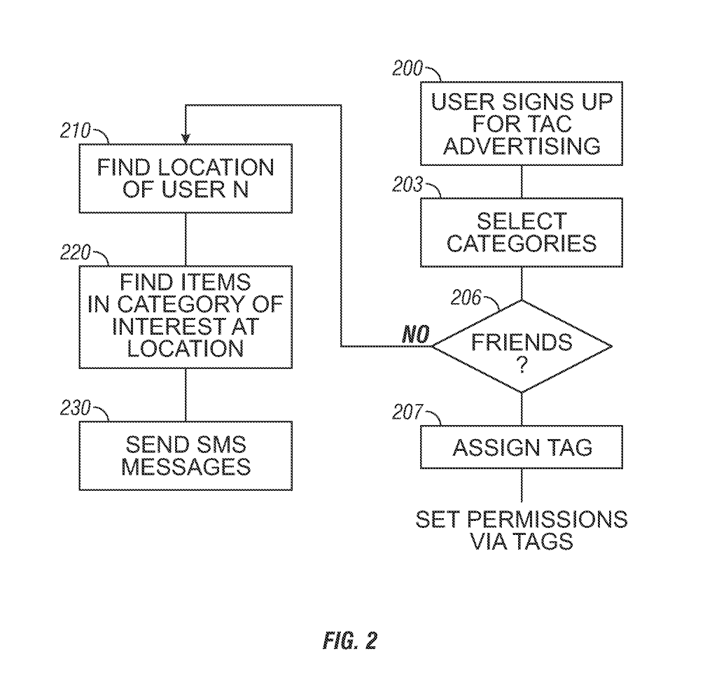

In operation, the users and/or cellular system carries out a flowchart of FIG. 2. Note that this can be executed on the central computer 130, and/or on the processors 111 of the local telephones.

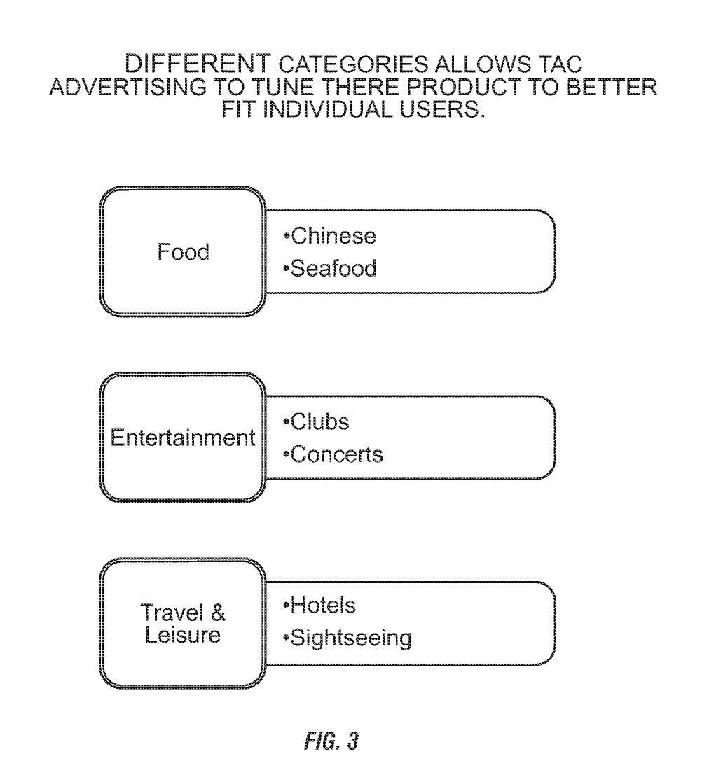

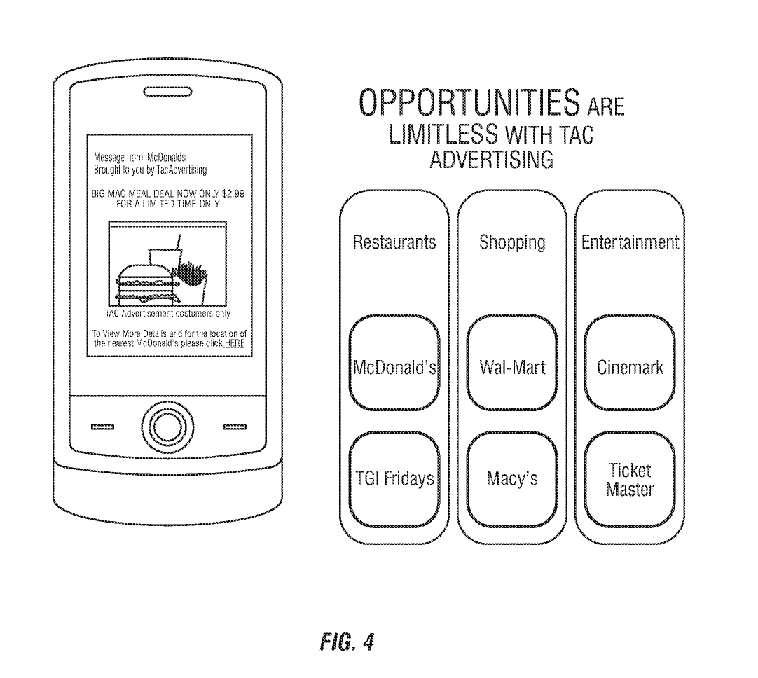

The initial step is carried out when the user signs up for the “ad” program at 200. The sign-up may provide various benefits for the user, but in general will keep the user informed of their interests based on their locations. At 205, the user selects among a number of different categories. These categories indicate which of the number of categories the user would like to get information. For example, the categories can include, as shown in FIG. 3, food, entertainment, travel and leisure, with each category having subcategories that the user can select. Other categories may also exist, such as restaurants, shopping, and entertainment. A sample screen that one might receive, is shown in FIG. 4. This shows the user sees a list of nearby restaurants. Each click on the restaurant goes to the screen shown as 400. This provides information about special deals at the restaurant that are obtained by this system, and also allows the user a link to click that provides them with more information about the nearest restaurant of this type or any other type.

Another function of the advertising system provides users with an immediate interactive experience based on their detected locations. Therefore, after opting in, the system finds the location of user and at 210. For example this may be done by triangulating between cell towers or using other cellular techniques such as GPS or WAP.

At 220, the computer finds, in its prestored database, items of interest in the selected category of interest, near the user's current location and happening at or near the current time. These items of interest may be for example events and promotions which are occurring currently near the user's current location. For example, the user might have opted in to the “comic book” events. A user in City X is told that “Comic Book convention, Starting Now”. This facilitates that user always being able to find something unique to their style. Since the events and promotions may be current and limited time items, SMS messages are used to get the information to the user immediately.

At 230, SMS messages are sent about the current items. SMS messages are sent because the information is immediate. Rather than sending information about things that will happen in the future, this sends information that is happening now, so that users receive SMS messages about things that are happening now in their own area.

Having categories allows the system, referred to herein as the TAC Advertising system, to fit the lifestyles of anyone. Examples of disparate lifestyles may include “rock out loud” college student wanting the details of every concert around. Similarly, a traveling business man may be looking for an amazing deal on a hotel. A full time mother may be looking for a good price on feeding her family on the run.

The above refers to advertisements, since it is referring to advertised local information at hotels, restaurants, etc.

Another embodiment describes using this system for social networking and friend finding. “TAC Friends” allows users to connect via text message on their cell phones. TAC Friends lets users talk and chat on their cell phones, as well as send multimedia messages to one another. Importantly, this operates to determine possible new friends in an area that is close to a user's current location

In order to operate in the friends embodiment, the categories 205 may be selected to include groups that represent interests. TAC Friends gives users the option to join and be a part of different groups such as Dating, Politics, or Business, Sports and/or Music, as well as many others.

When enlisted in select groups such as Dating, your TAG is then listed under that category. After a user's individual TAG is listed, other users will then be allowed to view that user's TAG and thereafter contact that user.

The flowchart of FIG. 2 illustrates how the user can sign up for the friends embodiment. When the user is detected at 206 as signing up for the friends embodiment, users are assigned a unique twelve digit numerical or alphanumeric TAG at 207. The TAG is what identifies individual users as well as keeps them safe on the web, in essence acting as an alias for the user. Each users TAG is linked directly to their phone number. When TAC Friends users (A) attempt to contact others (B), the TAG is what users (A) is able to view depending on users (B) privacy settings.

This has discussed using the unique TAG for the friends embodiment, however, this may also be used with the advertisements embodiment.

Each users TAG has privacy settings that are fully customizable. Since privacy is very important to TAC Friends, the TAG is able to be hidden from the public and shown on each user's page only if the user chooses to show it. Users can have their TAG visible to just friends or everyone.

Even if users don't want their TAG shown to the public, unknown users can still send a TAG request to become that user's friend. This allows users to retain their privacy without having to give up features of TAC Friends.

The TAC Friends list of categories is intended to have something for everyone. Once users find a category that appeals to them, they simply add their TAG to that specific category. Every user included in the individual categories has access to viewing any added TAG. Once a part of the categories users can start party conversations with multiple user or have one on one messaging to ask questions, share opinions, or just converse via text message.

If a user meets someone virtually, they can be added to the friends list on the web site. The list will then transfer to a compatible phone with a simple click. They friends list thus follows the phone. Since the chatting is mainly done via text message you will be able to talk to virtually anyone, anywhere.

Since MySpace and Facebook only have computer based messaging services, users can not connect in a practical manner on the run. One embodiment may define a plug in for existing networking systems like MySpace and Facebook.

TAC Friends encourages user to chat via text so users do not always need to be on the web site.

An advantage of this system is that since this social networking system operates via text messages, any text enabled phone can be used, which is virtually any phone in the world. Moreover, while other sites such as Facebook and MySpace intended for a user to interact via graphical user interface, they are less optimized for use on a cell phone. This system, where the communications are performed via text messages may be more efficiently used on a cell phone.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, this refers to one specific kind of social networking system; however other websites and systems that communicate between users can be operated in this way.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

When operated on a computer, the computer may include a processor that operates to accept user commands, execute instructions and produce output based on those instructions. The processor is preferably connected to a communication bus. The communication bus may include a data channel for facilitating information transfer between storage and other peripheral components of the computer system. The communication bus further may provide a set of signals used for communication with the processor, including a data bus, address bus, and/or control bus.

The communication bus may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCl”) local bus, or any old or new standard promulgated by the Institute of Electrical and Electronics Engineers (“IEEE”) including IEEE 488 general-purpose interface bus (“GPIB”), and the like.

A computer system used according to the present application preferably includes a main memory and may also include a secondary memory. The main memory provides storage of instructions and data for programs executing on the processor. The main memory is typically semiconductor-based memory such as dynamic random access memory (“DRAM”) and/or static random access memory (“SRAM”). The secondary memory may optionally include a hard disk drive and/or a solid state memory and/or removable storage drive for example an external hard drive, thumb drive, a digital versatile disc (“DVD”) drive, etc.

A least one possible storage medium is preferably a computer readable medium having stored thereon computer executable code (i.e., software) and/or data thereon in a non-transitory form. The computer software or data stored on the removable storage medium is read into the computer system as electrical communication signals.

The computer system may also include a communication interface. The communication interface allows' software and data to be transferred between computer system and external devices (e.g. printers), networks, or information sources. For example, computer software or executable code may be transferred to. computer system 550 from a network server via communication interface. The communication interface may be a wired network card, or a Wireless, e.g., Wifi network card.

Software and data transferred via the communication interface are generally in the form of electrical communication signals.

Computer executable code (i.e., computer programs or software) are stored in the memory and/or received via communication interface and executed as received. The code can be compiled code or interpreted code or website code, or any other kind of code.

A “computer readable medium” can be any media used to provide computer executable code (e.g., software and computer programs and website pages), e.g., hard drive, USB drive or other. The software, when executed by the processor, preferably causes the processor to perform the inventive features and functions previously described herein.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of providing information to a user of a mobile device, comprising:
prestoring information about user interests of a user;
finding a current location of the user;
based on said information about said user interests and said current location, finding a local information of limited time that fits both said user interests and said current location; and
automatically sending a text message to said user about said local information of limited time.

2. A method as in claim 1, wherein said local information is an event that is occurring at an advertised location.

3. A method as in claim 2, wherein said local information is a special deal at a restaurant.

4. A method as in claim 2, wherein said local information is a special deal at a hotel.

5. A method as in claim 2, wherein said local information is a limited time meeting.

6. A method as in claim 1, wherein said user interests include interests to find local friends.

7. A method as in claim 6, wherein said local information is information about information to discuss with local friends.

8. A method as in claim 6, further comprising assigning an alphanumeric tag as an alias for the user.

9. A method as in claim 8, further comprising storing tags associated with categories, wherein information related to said categories is sent to an address associated with said tag.

10. A method as in claim 9, wherein said information related to said categories is messages from other users who are interested in a specific category.

11. A method of receiving information on a mobile device, comprising:
at a first time, sending information about user interests of a user;
sending a current location of the user;
receiving local information of limited time that fits both said user interests and said current location on said mobile device by text message.

12. A method as in claim 11, wherein said local information is an event that is occurring at an advertised location.

13. A method as in claim 12, wherein said local information is a special deal at a restaurant.

14. A method as in claim 12, wherein said local information is a special deal at a hotel.

15. A method as in claim 12, wherein said local information is a limited time meeting.

16. A method as in claim 11, wherein said user interests include interests to find local friends.

17. A method as in claim 16, wherein said local information is information about information to discuss with local friends.

18. A method as in claim 16, further comprising assigning an alphanumeric tag as an alias for the user.

19. A method as in claim 18, further comprising storing tags associated with categories, wherein information related to said categories is sent to an address associated with said tag.

20. A method as in claim 9, wherein said information related to said categories is messages from other users who are interested in a specific category.

21. A web site comprising:
a social networking website that allows and creates relationships between users; and
a module for said social networking website that sends text messages indicative of both information and messages between said users.
